(19) United States
(12) Patent Application Publication
(10) Pub. No.: US 2016/0309751 A1
(43) Pub. Date: Oct. 27, 2016

(54) FOOD PRODUCT AND METHOD OF PREPARATION

(71) Applicants: Grain Processing Corporation, Muscatine, IA (US); Kent Precision Foods Group, Inc., St. Louis, MO (US)

(72) Inventors: Jacinta Kemboi, Superior, WI (US); Tonya J. Armstrong, Muscatine, IA (US)

(73) Assignees: KENT PRECISION FOODS GROUP, INC., St. Louis, MO (US); GRAIN PROCESSING CORPORATION, Muscatine, IA (US)

(21) Appl. No.: 14/697,214

(22) Filed: Apr. 27, 2015

(51) Int. Cl. A23L 1/212

(52) U.S. Cl. CPC A23L 1/2123; A23V 2002/00

(57) ABSTRACT

Disclosed are a method for preparing an extruded product and an extruded product prepared thereby. The extruded product is deemed useful a food product, in particular, a snack food product suitable for consumption by diabetics. Cranberry seed meal is blended with one or more starches, preferably including a modified dent corn starch, and extruded through a die under conditions suitable to result in an expanded product while exhibiting a 10% survival rate of at least one anthocyanin. Optionally, flavoring components such as spices may be incorporated into the blend or added after extrusion. The resulting food product will be suitable for a use as a snack food product but will have a substantially higher percentage of fiber and protein as compared with extruded carbohydrate-based food products, and will have some surviving anthocyanins.

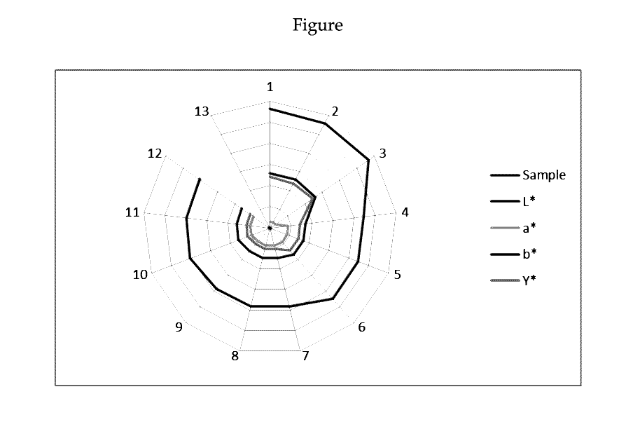

### FIELD

The disclosure is in the field of food and feed products. In some embodiments the disclosed invention is a food product suitable for use as a snack food product. The snack food product is intended for consumption by the general public but can be made especially suitable for consumption by diabetics.

### BACKGROUND

Diabetes is a disorder in which the level of blood glucose is persistently raised above the normal range. Diabetics generally must control the level of blood sugar with exercise, medication, insulin, and the like. In the last several years, the addition of cranberry is to the diet of diabetics has been believed to play a beneficial role due to the presence of phenolic anthocyanin compounds found in cranberry. At least one study has demonstrated lower insulin levels in patients for cranberry-supplemented subjects.

In the production of cranberry oils, the primary byproduct is cranberry seed meal and a secondary byproduct is cranberry seed flour. Generally, cranberry seeds are left over after raw cranberries are processed to extract cranberry juice. The juice may be extracted from cranberries in a “hot press” process in which heat is used to kill microorganisms, or via a “cold press” process. In either case, from the remnant seeds, cranberry seed oil may be extracted. Typically, about one standard truck-load of cranberry seeds is necessary for the production of five gallons of cranberry seed oil; for this reason, cranberry seed oil is quite expensive. Preparation of cranberry seed meal is described generally in U.S. Pat. Nos. 6,391,345; 6,733,798; and 8,124,142. Cranberry seed meal is generally deemed to be a low-value product that is typically ploughed back into the soil or used as an animal feed supplement, although a small amount of cranberry seed meal is used by the cosmetic industry. Few if any human food products are made with cranberry seed meal.

### SUMMARY

It has now been found that a seed meal that contains anthocyanins, such as cranberry seed meal, may be extruded with a starch to form an expanded extruded product. The extrusion may be conducted under circumstances that permit some of the anthocyanins present in the seed meal to survive the extrusion process.

In some embodiments, cranberry seed meal containing at least one anthocyanin is blended with a starch to form a blend. The blend is extruded through a die under selected conditions effective to create an expanded extrudate; the extrudate exhibiting a survival rate of at least 10% of at least one anthocyanin. Anthocyanins of interest can include, for example, cyanidin-3-galactoside, cyanidin-3-arabinoside, cyanidin-3-glucoside, peonidin-3-galactoside, peonidin-3-arabinoside, and peonidin-3-glucoside. Preferably, the extrudate exhibits a survival rate of at least 10% of at least one and in some cases at least two of these anthocyanins.

A food product prepared in accordance with the above method is encompassed by some embodiments of the invention. The food product may be an animal feed, but in many embodiments takes the form of a human food product and in many cases a snack food product. A snack product provided in this form can have an appearance and texture that are comparable to those of conventional extruded carbohydrate-based snack food products. Also provided in some embodiments are methods for providing nutrition, the methods including providing or consuming the food product described above.

### DESCRIPTION OF THE FIGURE

The FIGURE is a color space plot taken from the data presented in Example 6.

### DETAILED DESCRIPTION

Anthocyanins are water-soluble vacuolar pigments that generally belong to the flavonoid family of plant metabolites. Anthocyanins are found in leaves, stems, roots, flowers, and fruits of many plants. Chemically, anthocyanins are glucosides of anythocyanidins. Anthocyanins have been used in folk medicine throughout the worlds, and, in more recent modern scientific study, have been linked to a range of health benefits. In particular, anthocyanins are believed to provide certain health benefits for diabetics. Although the mechanism of action of anthocyanins is not known with certainty, it is believed that anthocyanins may lower blood glucose by improving insulin resistance, increasing secretion of insulin, or reducing digestion of sugars in the small intestine. Some or all of these effects may be due to the antioxidant properties of anthocyanins, although some of these effects potentially are due to enzymatic inhibition or other metabolic pathways.

Seed meals are believed to contain anthocyanins. For instance, cranberries are believed to contain the anthocyanins cyanidin-3-galactoside, cyanidin-3-arabinoside, cyanidin-3-glucoside, peonidin-3-galactoside, peonidin-3-arabinoside, and peonidin-3-glucoside. In the processing of juice and cranberry oil to leave a cranberry seed meal, it is believed that these anthocyanins will be present in the seed meal. As heretofore discussed, there are a number of known commercial methods for processing cranberries to yield cranberry juice and cranberry seed flour, some of which involve “hot press” techniques that employ the application of heat and some of which employ “cold press” techniques. Hot press techniques are generally undesirable in the context of the present invention inasmuch as the heat can destroy much or all of the anthocyanin content of the starting material, although it is contemplated that seed meal from a hot press extraction still may be used in conjunction with the present invention. More preferred is seed meal from a “cold press” technique in which heat is not employed.

Generally, the seed meal, such as the cranberry seed meal, is blended with starch and other optional ingredients and extruded through a die to form an expanded extrudate. The extruded blend may contain any suitable amount of seed meal, and thus, for instance, the seed meal may be present in an amount of 5%, 10%, 15%, 20%, 25%, 30%, 35%, 40%, 45%, 50%, 55%, 60%, 65%, 70%, 75%, 80%, 85%, 90% or 95% in the blend. Mixtures of seed meals may be employed with the total amount of seed meal present in the foregoing amounts. Where plural seed meals are employed, they may be present in any amounts relative to one another. In some embodiments, the seed meal is present in a total amount of about 5-40%; in other embodiments, the seed meal is present in a total amount of about 10-35%. Generally, the seed meal includes anthocyanins, and thus, in the case of cranberry seed meal, for instance, the seed meal contains cyanidin-3-galactoside, cyanidin-3-arabinoside, cyanidin-3-glucoside, peonidin-3-galactoside, peonidin-3-arabinoside, and peonidin-3-glucoside.

The cranberry meal is blended with starch, by which is contemplated any suitable starch derived from any suitable source. For example, the starch may be a corn starch, a waxy starch, a high-amylose starch, wheat starch, potato starch, rice starch, tapioca starch, sago starch, or sorghum starch. Mixtures of such starches may be employed. The starch or starches may be present in any suitable amount, such as 5%, 10%, 15%, 20%, 25%, 30%, 35%, 40%, 45%, 50%, 55%, 60%, 65%, 70%, 75%, 80%, 85%, 90% or 95% by weight of the extruded blend. When multiple starches are employed, they may be present in any suitable amount relative to one another. In some embodiments, an expansion-enhancing starch may be included in the blend. It is believed that certain starches, in particular certain acid-modified starches, will partially degrade in the conditions of the extruder to form carbon dioxide to a greater extent than dent corn starch, thus desirably enhancing the expansion of the extrudate as it exits the die. One suitable acid-modified starch is PURE-SET B965, available from Grain Processing Corporation of Muscatine, Iowa. When employed, such an expansion-enhancing starch can be present in any suitable amount, such as 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, or 15% by weight of the blend.

The product may further include a grain or cereal component, the function of which is to provide structure and texture and in some cases flavor to the extruded blend. For instance, the product may be a flour or meal derived from corn, rice, potato, cassava, wheat, sorghum, or any other suitable grain or cereal. Mixtures of multiple grains or cereals may be employed as desired. When present, the grain or cereal component may be present in an amount of 5%, 10%, 15%, 20%, 25%, 30%, 35%, 40%, 45%, 50%, 55%, 60%, 65%, 70%, 75%, 80%, 85%, 90% or 95% by weight of the blend. When multiple such components are employed, they may be present in any suitable amount relative to one another. For instance, the blend may be fashioned with Proso millet and corn meal.

The blend may be provided with flavoring additives, although as contemplated that such additives may be employed alternatively or in addition thereto at other stages of the process of preparation of the food product. Such components may be present in any amount suitable to impart flavor, as desired. For example, the blend may include salt. If used, salt may be present in any suitable amount, such as an amount of 0.01-2% by weight of the blend, or for example 0.01-1%.

Once the blend is formed, it is extruded through a die under conditions suitable to form an expanded extrudate, generally while permitting survival of some of the anthocyanin content of the seed meal in the blend. Any suitable extruder may be employed in conjunction with the invention. Exemplary teachings concerning extruders may be found in U.S. Pat. Nos. 8,951,594; 8,263,163; 8,192,663; 7,595,015; and 7,727,443, all assigned to Grain Processing Corporation of Muscatine, Iowa. In the extruder, the blend is subjected to a shearing force in the presence of moisture and heat and then passed through a die, whereupon the extrudate expands to form an expanded extrudate. The extruder may be a single-screw extruder or a twin-screw extruder or other suitable extruder. Generally, the extruder includes a barrel and die, and in practice other components such as preconditioners, steam or water jackets, and numerous other components as may be conventional or otherwise suitable for use in conjunction with the present invention.

Many commercial extruders include at least first and second zones, and in many cases multiple zones, in which the temperature may be varied. Commercially available extruders useful in conjunction with the invention include those available from Wenger of Sabetha, Kans., such as the Wenger TX57 and TX144 extruders. The moisture content in the extruder may be any suitable amount; for instance, it may range from 10-50% by total weight of the material in the extruder, and the temperature in the extruder may be set to any valuable suitable for use in conjunction with the invention, such as values ranging from 50°-150° C. These values may vary depending on operating conditions and location and the composition of the feed blend.

Generally, the conditions in the extruder should be selected and controlled such that the resulting product exhibits some survival of anthocyanins. Although it is not intended to limit the invention to a particular theory of operation, it is believed that some of the heat and work energy in the extruder becomes consumed by gelatinization of the starch or other process involving the starch, with the starch acting as a “buffer” and thereby permitting some of the anthocyanins to survive. In one extrusion, a twin-screw Wegner TX57 extruder having a width of 57 mm and a diameter of 4 mm and a length/diameter ratio of 25:1 was employed. The initial moisture content of the blend was about 12%. With a 30% motor load, the blend was extruded at a feed screw speed of 12 rpm and a shaft speed of 300 rpm with a barrel temperature profile of 30, 57, 90, 124, and 121 degrees C. in the various zones of the extruder and a knife speed of 431 rpm. These conditions were found suitable to provide an exemplary expanded product.

After extrusion, the extrudate is generally dried, for example, in a multi-zone drier. Any suitable drying temperature or temperatures may be employed; for instance, the drier may have two successive zones set to 87° and 115° C. respectively. Flavoring components may be introduced at any suitable point in the process. In some case, the flavoring components may be introduced to the blend prior to extrusion. In other cases, the components may be added after extrusion and before drying. It is envisioned that any suitable flavoring component may be added, such as roasted garlic, garlic and chili, jalapeno, chipotle, salt and pepper, barbeque, sweet and spicy, sour cream and onion, cinnamon and sugar, or other sweet or savory flavorings may be employed.

Upon cooling, the product may be packaged. It is contemplated that the packaging may be “individual-serve” packages such ranging from 2 oz.-8 oz., to “family-serve” packages ranging from over 8 oz. to 32 oz., to “food service” packages ranging from over 32 oz. to 160 oz., to larger “transport” packages intended for downstream packaging. Suitable conventional packaging equipment may be employed for this purpose.

It is contemplated that the extruded product will include at least one anthocyanin from the cranberry seed meal, despite the heat and work imparted by the extruder. The anthocyanin survival rate should be at least 10% and may for example be at least 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5% or 20%. The anthocyanin survival rate is based on comparison of anthocyanin content in the extrudate vs. in the blend prior to extrusion and may be determined using HPLC analysis as discussed in the Examples hereinbelow. The amount of survival may be determined as an average percentage taken over multiple runs, for example 3 runs.

The resulting extrudate can be in many embodiments provided in a form that has substantial amounts of fiber and protein as compared to many other carbohydrate-based extruded products. It has been observed that the color of the product will range from a light brown to a dark brown, with higher amount of cranberry seed meal corresponding to a darker extrudate. If desired, coloring agents may be employed to alter the color of the extrudate. With or without additional flavoring components, the product formed may be commercially acceptable and suitable for consumption by the general population and suitable as a snack food for diabetics, given the relatively high fiber and protein contents that can be attained. The protein content, for instance, can be at least about 7.5%; in some embodiments, at least about 8.0%; in some embodiments, at least about 8.5%; in some embodiments; at least about 9.0%; in some embodiments, at least about 9.5%; in some embodiments, at least about 10.0%; and in some embodiments, at least about 10.5%. The fiber content, for instance, can be at least about 6%; in some embodiments, at least about 6.5%; in some embodiments, at least about 7.0%; in some embodiments, at least about 7.5%; in some embodiments, at least about 8.0%; in some embodiments, at least about 8.5%; in some embodiments; at least about 9.0%; in some embodiments, at least about 9.5%; in some embodiments, at least about 10.0%; in some embodiments, at least about 10.5%; in some embodiments, at least about 11.0%; in some embodiments, at least about 11.5%; in some embodiments, at least about 12.0%; in some embodiments, at least about 12.5%; in some embodiments, at least about 13.0%; in some embodiments; at least about 13.5%; in some embodiments, at least about 14.0%; in some embodiments, at least about 14.5%; in some embodiments, at least about 15.0%; in some embodiments, at least about 15.5%; in some embodiments, at least about 16.0%; in some embodiments, at least about 16.5%; in some embodiments, at least about 17.0%; in some embodiments, at least about 17.5%; in some embodiments, at least about 18.0%; in some embodiments; at least about 18.5%; in some embodiments, at least about 19.0%; in some embodiments, at least about 19.5%; and in some embodiments, at least about 20.0%.

The product may take the form of an animal feed or human food product. In many embodiments, the expanded extrudate will be a human food product. It can be provided to, or consumed by a diabetic person or by a nondiabetic person.

The following examples are provided to illustrate certain embodiments of the present invention but are not limiting in scope.

### EXAMPLES

### Example 1

### Evaluation of Anthocyanin Content in Cranberries and Cranberry Seed Meal

Reference standards of five anthocyanins were obtained from Cerilliant Analytical Reference Standards of Round Rock, Tex. The five standards were cyanadine-3-glucoside cyanidin-3-galactoside, cyanidin-3-arabinoside, peonidin-3-galactoside, and peonidin-3-glucoside. The cyanidin reference standards were solids while the peonidin standards were provided in a 500 μg/ml solution. The solid reference compounds were used to prepare analytical standards in extraction solvent (33% methanol-2% hydrochloric acid in Milli-Q (purified) water. Sub-stocks were prepared from the analytical standards and the sub stocks were used to create working standards that contained all five anthocyanins. The working standards were used to prepare analytical calibration curves for each anthocyanin. Upon receipt and when not in use, the reference standards and the standards prepared therefrom were stored in a freezer.

### Example 2

### Determination of Anthocyanin Content

Following the method described in “Determinations Of Anthocyanins In Cranberry Fruit And Cranberry Fruit Products By High-Performance Liquid Chromatography With Ultraviolet Detection: Single-Laboratory Validation,” Journal of Association of Analytical Communities (AOAC) International 2011:94(2): 459-66, the concentration of anthocyanins in each of the following samples was determined.

Sample 1 From Cranberry seeds

Sample 2 Germinated Cranberry Seed M

Sample 3 Cranberry Seed Meal CRQC120209-M

Sample 4 Cranberry Seed Meal CRQC120913-M

Sample 5 Organic Cranberry Seed Meal CRQC120511-M ORG

Sample 6 Organic Cranberry—Pestle & Mortar CRQC130424-M ORG

Sample 9 Cranberry Seed Meal—Botanic Innovations Lot #CRQC1304-S

Sample 10 Organic Cranberry CRQC130424-M ORG Refrigerated on grounding

The analysis was conducted using an Agilent Model 1290 Infinity ultrahigh performance liquid chromatograph system at the University of Wisconsin—Superior. A Phenomenex Kinetix 2.6μ XB-C18 analytical column (100×3.0 mm) was used to separate compounds present in the standards and extracts. Peaks were detected on a diode array detector at a wavelength of 520 mm using a bandpass of 8 mm. Analysis was conducted using radiant eluent employing 2 eluents. Eluent A was a 99.5% Milli-Q water/0.5 phosphoric acid (Alfa Aesar, ACS, 85%). Eluent B was 50% Milli-Q water, 48.5% acetonitrile (B&J, HPLC grade) 1.0% glacial acetic acid (Alfa Aesar, ACS, 99.7%) and 0.5% phosphoric acid (Alfa Aesar, ACS, 85%). The gradient program with a mobile phase flow rate of 0.70 mL was: 1.0 min. 90% A/10% B; 13.0 min. 72% A/28% B; 17.0 min. 25% A/75% B; 17.1 min. 90% A/10% B; 20.0 min. 90% A/10% B. A 2.0 minute post-time was also employed. Ten microliter injections of all standards and samples were made.

Samples were prepared for analysis by carrying them through an extraction procedure to remove the anthocyanins from the solid samples. Each sample was carried through the entire extraction and analysis procedure in triplicate. The extraction solvent that was used was 33% methanol (B&J, HPLC grade)/2% hydrochloric acid (Fisher Scientific, Cert. ACS Plus) in Milli-Q water. Approximately 0.25 g samples were weighed into 85 mL polycarbonate centrifuge tubes and 20 mL of extraction solvent was added to each tube. The samples were mixed on a vortex mixer for 10 seconds followed by sonication for 15 minutes in an ultrasonic bath. Samples were then shaken at 180 rpm for 30 minutes on a platform shaker. Samples were again mixed on the vortex mixer for ten seconds and then centrifuged at 5000 rpm for five minutes at 23° C. After the centrifugation, the samples were carefully decanted into 25 mL volumetric flasks and diluted to volume with extraction solvent. During the decantation, a small amount of the solids were unintentionally transferred to the volumetric flasks. The volumetric flasks were inverted a minimum of ten times and were vigorously shaken to ensure the samples were homogeneous. Approximately 1.0 mL of each sample extract was filtered through a 0.45 g nylon syringe filter into an amber autosampler vial. Samples were either immediately placed in the UHPLC autosampler for analysis or stored in a freezer until analysis was conducted.

The following results were obtained for tested samples and for the sub-stocks prepared from the reference standards. Different data entries reflect the fact that the samples were analyzed on different dates.

Results of Analysis of Cranberry Project Standards and Samples

| | Analyzed Conc. (mg/L) | | | | % of Theoretical Value | | | |
|---|---|---|---|---|---|---|---|---|
| Standard | C-3-Ga | C-3-Ar | C-3-Gl | P-3-Ga | C-3-Ga | C-3-Ar | C-3-Gl | P-3-Ga |
| Std. 1 | 0.79 | 0.73 | 0.72 | 0.64 | 102.6 | 102.8 | 100 | 98.5 |
| Std. 2 | 3.03 | 2.83 | 2.80 | 2.55 | 99.0 | 99.3 | 96.9 | 98.1 |
| Std. 3 | 12.1 | 11.5 | 11.3 | 10.3 | 98.4 | 100.9 | 97.4 | 99.0 |
| Std. 4 | 48.5 | 45.8 | 45.1 | 41.2 | 99.0 | 100.4 | 97.4 | 98.8 |
| Std. 3 | 12.1 | 11.5 | 11.3 | 10.3 | 98.4 | 100.9 | 97.4 | 99.0 |
| Std. 2 | 3.05 | 2.83 | 2.81 | 2.56 | 99.7 | 99.3 | 97.2 | 98.5 |

| Sample | Wt. (g) | Analyzed Conc. (mg/L) | | | | Conc. mg/kg (Wet weight basis) | | |
|---|---|---|---|---|---|---|---|---|
| Sample 1-1 | 0.253 | 2.42 | ND | 2.32 | 4.57 | 239.1 | 229.2 | 451.6 |
| Sample 1-2 | 0.262 | 2.48 | ND | 2.36 | 4.73 | 236.6 | 225.2 | 451.3 |
| Sample 1-3 | 0.252 | 2.32 | ND | 2.22 | 4.43 | 230.2 | 220.2 | 439.5 |
| Mean | | | | | | 235.3 | 224.9 | 447.5 |
| Sample 2-1 | 0.250 | 0.372 | ND | 0.571 | 0.952 | 37.2 | 57.1 | 95.2 |
| Sample 2-2 | 0.249 | 0.374 | ND | 0.575 | 0.952 | 37.6 | 57.7 | 95.6 |
| Sample 2-3 | 0.252 | 0.375 | ND | 0.585 | 0.966 | 37.2 | 58.0 | 95.8 |
| Mean | | | | | | 37.3 | 57.6 | 95.5 |

| | Analyzed Conc. (mg/L) | | | | % of Theoretical Value | | | |
|---|---|---|---|---|---|---|---|---|
| Standard | C-3-Ga | C-3-Ar | C-3-Gl | P-3-Ga | C-3-Ga | C-3-Ar | C-3-Gl | P-3-Ga |
| Std. 3 | 12.1 | 11.3 | 11.4 | 10.4 | 98.4 | 99.1 | 98.3 | 100.0 |
| Std. 2 | 3.02 | 2.81 | 2.84 | 2.58 | 98.7 | 98.6 | 98.3 | 99.2 |
| Std. 3 | 12.1 | 11.2 | 11.3 | 10.3 | 98.4 | 98.2 | 97.4 | 99.0 |

| | Sample | | | | | | | |
|---|---|---|---|---|---|---|---|---|
| Sample | Wt. (g) | Analyzed Conc. (mg/L) | | | | Conc. mg/kg (Wet weight basis) | | |
| Sample 1-1 | 0.253 | 2.44 | ND | 2.33 | 4.59 | 241.1 | 230.2 | 453.6 |
| Sample 3-1 | 0.254 | 2.23 | ND | 2.17 | 3.69 | 219.5 | 213.6 | 363.2 |
| Sample 3-2 | 0.259 | 2.60 | ND | 2.70 | 4.21 | 251.0 | 260.6 | 406.4 |
| Sample 3-3 | 0.253 | 2.57 | ND | 2.64 | 4.15 | 254.0 | 260.9 | 410.1 |
| Mean | | | | | | 241.5 | 245.0 | 393.2 |
| Sample 4-1 | 0.263 | 2.30 | ND | 2.30 | 3.53 | 218.6 | 218.6 | 335.6 |
| Sample 4-2 | 0.250 | 2.21 | ND | 2.21 | 3.39 | 221.0 | 221.0 | 339.0 |
| Sample 4-3 | 0.255 | 2.18 | ND | 2.20 | 3.36 | 213.7 | 215.7 | 329.4 |
| Mean | | | | | | 217.8 | 218.4 | 334.7 |
| Sample 5-1 | 0.249 | 1.59 | ND | 1.51 | 2.56 | 159.6 | 151.6 | 257.0 |
| Sample 5-2 | 0.253 | 1.59 | ND | 1.55 | 2.61 | 157.1 | 153.2 | 257.9 |
| Sample 5-3 | 0.252 | 1.57 | ND | 1.52 | 2.57 | 155.8 | 150.8 | 255.0 |
| Mean | | | | | | 157.5 | 151.9 | 256.6 |
| Sample 6-1 | 0.25 | 1.44 | ND | 1.28 | 2.42 | 144.0 | 128.0 | 242.0 |
| Sample 6-2 | 0.255 | 1.49 | ND | 1.36 | 2.56 | 146.1 | 133.3 | 251.0 |
| Sample 6-3 | 0.251 | 1.45 | ND | 1.30 | 2.45 | 144.4 | 129.5 | 244.0 |
| Mean | | | | | | 144.8 | 130.3 | 245.7 |

| | | Analyzed Conc. (mg/L) | | | | % of Theoretical Value | | | |
|---|---|---|---|---|---|---|---|---|---|
| Standard | Sample | C-3-Ga | C-3-Ar | C-3-Gl | P-3-Ga | C-3-Ga | C-3-Ar | C-3-Gl | P-3-Ga |
| Std. 3 | | 12.1 | 11.3 | 11.3 | 10.2 | 98.4 | 99.1 | 97.4 | 98.1 |
| Std. 2 | | 3.03 | 2.82 | 2.82 | 2.56 | 99.0 | 98.9 | 97.6 | 98.5 |
| Std. 3 | | 12.1 | 11.3 | 11.3 | 10.3 | 98.4 | 99.1 | 97.4 | 99.0 |
| Sample 9-1 | 0.251 | 2.02 | | 2.09 | 3.07 | 201.2 | | 208.2 | 305.8 |
| Sample 9-2 | 0.257 | 2.04 | | 2.17 | 3.08 | 198.4 | | 211.1 | 299.6 |
| Sample 9-3 | 0.261 | 2.04 | | 2.11 | 3.07 | 195.4 | | 202.1 | 294.1 |
| Mean | | | | | | 198.3 | | 207.1 | 299.8 |
| Sample 10-1 | 0.249 | 1.55 | | 1.38 | 2.62 | 155.6 | | 138.6 | 263.1 |
| Sample 10-2 | 0.264 | 1.69 | | 1.54 | 2.87 | 160.0 | | 145.8 | 271.8 |
| Sample 10-3 | 0.253 | 1.58 | | 1.43 | 2.68 | 156.1 | | 141.3 | 264.8 |
| Mean | | | | | | 157.3 | | 141.9 | 266.6 |
| Sample 1-1 | 0.253 | 2.43 | | 2.32 | 4.58 | 240.1 | | 229.2 | 452.6 |
| (earlier) | | | | | | | | | |

### Example 3

### Moisture Content Determination

The moisture contents of the foregoing samples were determined by drying the samples in an oven set at 105 degrees for 16 hrs. and determining the percent calculated via weight reduction. The following results were obtained.

Percent Moisture Determination

| | | Pan + | | Pan + | | | |
|---|---|---|---|---|---|---|---|
| | Pan | Wet | Wet | Dry | Dry | Wt. | % |
| | Wt. | Sample | Wt. | Sample | Wt. | Loss | Mois- |
| Sample | (g) | (g) | (g) | (g) | (g) | (g) | ture |
| 1 | 0.735 | 1.701 | 0.966 | 1.657 | 0.922 | 0.044 | 4.55 |
| 2 | 0.735 | 1.688 | 0.953 | 1.633 | 0.898 | 0.055 | 5.77 |
| 3 | 0.734 | 2.03 | 1.296 | 1.996 | 1.262 | 0.034 | 2.62 |
| 3 Dup | 0.730 | 1.930 | 1.200 | 1.898 | 1.168 | 0.032 | 2.67 |
| 4 | 0.735 | 1.748 | 1.013 | 1.717 | 0.982 | 0.031 | 3.06 |
| 5 | 0.740 | 1.801 | 1.061 | 1.773 | 1.033 | 0.028 | 2.64 |
| 6 | 0.738 | 1.744 | 1.006 | 1.710 | 0.972 | 0.034 | 3.38 |
| 9 | 0.734 | 1.8 | 1.066 | 1.761 | 1.027 | 0.039 | 3.66 |
| 10 | 0.733 | 1.817 | 1.084 | 1.806 | 1.073 | 0.011 | 1.01 |

### Example 4

Anthocyanin content after freezing, after storing the samples in a freezer, the anthocyanin content was again evaluated, yielding the following results. The reference stated sub-stocks were also reevaluated. The following results were obtained.

| | Analyzed Conc. (mg/L) | | | | | % of Theoretical Value | | | | |
|---|---|---|---|---|---|---|---|---|---|---|
| Standard | C-3-Ga | C-3-Gl | C-3-Ar | P-3-Ga | P-3-Gl | C-3-Ga | C-3-Gl | C-3-Ar | P-3-Ga | P-3-Gl |
| Std. 1 | 0.64 | 0.61 | 0.62 | 0.55 | 0.59 | 104.9 | 105.2 | 112.3 | 105.8 | 101.7 |
| Std. 2 | 2.44 | 2.30 | 2.26 | 2.09 | 2.33 | 99.6 | 99.6 | 107.0 | 100.5 | 100.0 |
| Std. 3 | 9.68 | 9.14 | 8.97 | 8.2 | 9.3 | 98.8 | 98.8 | 106.0 | 98.4 | 99.7 |
| Std. 4 | 39.2 | 37.0 | 36.5 | 33.3 | 37.3 | 100.0 | 100.0 | 107.4 | 100.0 | 100.0 |
| Std. 3 | 9.63 | 9.13 | 9.00 | 8.30 | 9.34 | 98.3 | 98.7 | 105.5 | 99.6 | 100.1 |

| | | Analyzed Conc. (mg/L) | | | | | % of Theoretical Value | | | | |
|---|---|---|---|---|---|---|---|---|---|---|---|
| | | C-3-Ga | C-3-Gl | C-3-Ar | P-3-Ga | P-3-Gl | C-3-Ga | C-3-Gl | C-3-Ar | P-3-Ga | P-3-Gl |
| Standard | | | | | | | | | | | |
| Std. 1 | | 0.73 | 0.70 | 0.71 | 0.54 | 0.58 | 119.7 | 120.7 | 124.6 | 103.8 | 100.0 |
| Std. 2 | | 2.32 | 2.21 | 2.16 | 2.06 | 2.32 | 94.7 | 95.7 | 94.7 | 99.0 | 99.6 |
| Std. 3 | | 9.50 | 8.91 | 8.74 | 8.22 | 9.30 | 96.9 | 96.3 | 95.7 | 98.7 | 99.7 |
| Std. 4 | | 39.3 | 37.1 | 36.6 | 33.3 | 37.3 | 100.3 | 100.3 | 100.3 | 100.0 | 100.0 |
| Std. 3 | | 9.51 | 8.95 | 8.80 | 8.28 | 9.31 | 97.0 | 96.8 | 96.4 | 99.4 | 99.8 |
| Std. 1 | | 0.73 | 0.70 | 0.71 | 0.55 | 0.58 | 119.7 | 120.7 | 124.6 | 105.8 | 100.0 |
| Std. 2 | | 2.32 | 2.21 | 2.17 | 2.07 | 2.32 | 94.7 | 95.7 | 95.2 | 99.5 | 99.6 |
| Std. 3 | | 9.53 | 8.95 | 8.75 | 8.27 | 9.35 | 97.2 | 96.8 | 95.8 | 99.3 | 100.2 |
| Std. 4 | | 39.3 | 37.0 | 36.3 | 33.3 | 37.3 | 100.3 | 100.0 | 99.5 | 100.0 | 100.0 |
| Sample | | | | | | | | | | | |
| Sample 1-1 | 0.253 | 2.64 | 0.275 | 2.63 | 4.63 | 0.314 | 260.9 | 27.2 | 259.9 | 457.5 | 31.0 |
| Sample 1-2 | 0.262 | 2.75 | 0.270 | 2.73 | 4.87 | 0.324 | 262.4 | 25.8 | 260.5 | 464.7 | 30.9 |
| Sample 1-3 | 0.252 | 2.61 | 0.271 | 2.59 | 4.61 | 0.309 | 258.9 | 26.9 | 256.9 | 457.3 | 30.7 |
| Mean | | 2.67 | 0.27 | 2.65 | 4.70 | 0.32 | 260.7 | 26.6 | 259.1 | 459.8 | 30.9 |
| Sample 2-1 | 0.250 | 0.57 | ND | 0.847 | 1.04 | ND | 56.7 | — | 84.7 | 104.0 | — |
| Sample 2-2 | 0.249 | 0.58 | ND | 0.864 | 1.04 | ND | 58.0 | — | 86.7 | 104.4 | — |
| Sample 2-3 | 0.252 | 0.58 | ND | 0.855 | 1.02 | ND | 57.0 | — | 84.8 | 101.2 | — |
| Mean | | 0.57 | ND | 0.86 | 1.03 | ND | 57.3 | | 85.4 | 103.2 | |
| Sample 3-1 | 0.254 | 2.51 | 0.271 | 2.52 | 3.88 | 0.295 | 247.0 | 26.7 | 248.0 | 381.9 | 29.0 |
| Sample 3-2 | 0.259 | 2.90 | 0.271 | 3.12 | 4.42 | 0.330 | 279.9 | 26.2 | 301.2 | 426.6 | 31.9 |
| Sample 3-3 | 0.253 | 2.85 | 0.271 | 3.05 | 4.34 | 0.324 | 281.6 | 26.8 | 301.4 | 428.9 | 32.0 |
| Mean | | 2.75 | 0.27 | 2.90 | 4.21 | 0.32 | 269.5 | 26.5 | 283.5 | 412.5 | 31.0 |
| Sample 4-1 | 0.263 | 2.53 | 0.275 | 2.63 | 3.62 | 0.272 | 240.5 | 26.1 | 250.0 | 344.1 | 25.9 |
| Sample 4-2 | 0.250 | 2.44 | 0.268 | 2.57 | 3.5 | 0.223 | 244.0 | 26.8 | 257.0 | 350.0 | 22.3 |
| Sample 4-3 | 0.255 | 2.43 | 0.268 | 2.54 | 3.47 | 0.253 | 238.2 | 26.3 | 249.0 | 340.2 | 24.8 |
| Mean | | 2.47 | 0.27 | 2.58 | 3.53 | 0.25 | 240.9 | 26.4 | 252.0 | 344.8 | 24.3 |
| Sample 5-1 | 0.249 | 1.80 | 0.265 | 1.84 | 2.66 | 0.197 | 180.7 | 26.6 | 184.7 | 267.1 | 19.8 |
| Sample 5-2 | 0.253 | 1.84 | 0.261 | 1.88 | 2.71 | 0.192 | 181.8 | 25.8 | 185.8 | 267.8 | 19.0 |
| Sample 5-3 | 0.252 | 1.82 | 0.263 | 1.86 | 2.68 | 0.198 | 180.6 | 26.1 | 184.5 | 265.9 | 19.6 |
| Mean | | 1.82 | 0.26 | 1.86 | 2.68 | 0.20 | 181.0 | 26.2 | 185.0 | 266.9 | 19.5 |
| Sample 6-1 | 0.250 | 1.66 | 0.262 | 1.57 | 2.51 | 0.175 | 166.0 | 26.2 | 157.0 | 251.0 | 17.5 |
| Sample 6-2 | 0.255 | 1.72 | 0.258 | 1.66 | 2.62 | 0.196 | 168.6 | 25.3 | 162.7 | 256.9 | 19.2 |
| Sample 6-3 | 0.251 | 1.69 | 0.257 | 1.62 | 2.55 | 0.166 | 168.3 | 25.6 | 161.4 | 254.0 | 16.5 |
| Mean | | 1.69 | 0.26 | 1.62 | 2.56 | 0.18 | 167.7 | 25.7 | 160.4 | 253.9 | 17.7 |
| Sample 9-1 | 0.251 | 2.26 | 0.270 | 2.44 | 3.17 | 0.198 | 225.1 | 26.9 | 243.0 | 315.7 | 19.7 |
| Sample 9-2 | 0.257 | 2.29 | 0.264 | 2.48 | 3.19 | 0.212 | 222.8 | 25.7 | 241.2 | 310.3 | 20.6 |
| Sample 9-3 | 0.261 | 2.28 | 0.264 | 2.48 | 3.19 | 0.220 | 218.4 | 25.3 | 237.5 | 305.6 | 21.1 |
| Mean | | 2.28 | 0.27 | 2.47 | 3.18 | 0.21 | 222.1 | 26.0 | 240.6 | 310.5 | 20.5 |
| Sample 10-1 | 0.249 | 1.75 | 0.260 | 1.67 | 2.70 | 0.200 | 175.7 | 26.1 | 167.7 | 271.1 | 20.1 |
| Sample 10-2 | 0.264 | 1.93 | 0.263 | 1.81 | 2.97 | 0.191 | 182.8 | 24.9 | 171.4 | 281.3 | 18.1 |
| Sample 10-3 | 0.253 | 1.81 | 0.259 | 1.71 | 2.79 | 0.195 | 178.9 | 25.6 | 169.0 | 275.7 | 19.3 |
| Mean | | 1.83 | 0.26 | 1.73 | 2.82 | 0.20 | 179.1 | 25.5 | 169.3 | 276.0 | 19.1 |

### Example 5

The following blends were prepared:

| | | | | |
|---|---|---|---|---|
| Ingredients | Control | Trial 1 | Trial 2 | Trial 3 |

Percentage

| | | | | |
|---|---|---|---|---|
| Cranberry Seed | 0 | 12 | 24 | 36 |
| Meal | | | | |
| Proso Millet | 30 | 30 | 30 | 30 |
| Tapioca Starch | 29.95 | 29.95 | 29.95 | 29.95 |
| Corn Meal | 40 | 28 | 16 | 4 |
| Salt | 0.05 | 0.05 | 0.05 | 0.05 |

Weight (lbs.)

| | | | | |
|---|---|---|---|---|
| Cranberry Seed | 0 | 24 | 48 | 72 |
| Meal | | | | |
| Proso Millet | 60 | 60 | 60 | 60 |
| Tapioca Starch | 59.9 | 59.9 | 59.9 | 59.9 |
| Corn Meal | 80 | 56 | 32 | 8 |
| Salt | 0.1 | 0.1 | 0.1 | 0.1 |
| Total Blend | 200 | 200 | 200 | 200 |
| Weight | | | | |

These blends were extruded with a co-rotating twin-screw extruder (Wenger TX57) at a pilot plant in Muscatine, Iowa. The extruder had a width of 57 mm with a die diameter of 4 mm and a length/diameter ratio of 25:1. The initial moisture of the blends was 12%. With 30% motor load, the blends were extruded at a feed screw speed of 12 rpm and a shaft speed of 300 rpm with a barrel temperature profile of 30, 57, 90, 124 and 121 C and a knife speed of 431 rpm. The extrudates were then dried under twin dryers set at 87° and 115° C. and cooled. Once cooled, the samples were packaged in sealed polyethylene bags into a secondary cardboard barrel and stored in a cool dry place ready for sensory analysis. Extrusion conditions were as follows.

Extruder Data
Blends(% Cranberry seed Meal)

| | | | 12% | 24% | 36% |
|---|---|---|---|---|---|
| | Target | Control | Trial 1 | Trial 2 | Trial 3 |
| Raw Material | | | | | |
| Information | | | | | |
| Dry Recipe Rate lb./hr | 150 | 150 | 150 | 150 | 150 |
| Feed Screw Speed rpm | Record | 12 | 12 | 12 | 12 |
| Cylinder Information | | | | | |
| Cylinder Speed rpm | 300 | 300 | 300 | 300 | 300 |
| Extrusion Information | | | | | |
| Extruder barrel set up # | 7 | 7 | 7 | 7 | 7 |
| Extruder Shaft Speed | 300 | 300 | 300 | 300 | 300 |
| rpm | | | | | |
| Extruder Motor Load % | Record | 30 | 30 | 30 | 30 |
| Water Flow to Extruder | | 10 | 10 | 10 | 10 |
| lb./hr | | | | | |
| Knife Speed rpm | Record | 1308 | 1308 | 1306 | 1302 |
| No of Knives | 2 | 2 | 2 | 2 | 2 |
| Control Temp- 1st Head | 80-100 | 93 | 93 | 96 | 97 |
| Deg. F. | | | | | |
| Control Temp- 2nd Head | 150-170 | 145 | 145 | 142 | 143 |
| Deg. F. | | | | | |
| Control Temp- 3rd Head | 200-230 | 228 | 228 | 223 | 221 |
| Deg. F. | | | | | |
| Control Temp- 4th Head | 240-260 | 247 | 247 | 248 | 251 |
| Deg. F. | | | | | |
| Control Temp- 5th Head | 240-260 | 250 | 250 | 248 | 249 |
| Deg. F. | | | | | |
| Die hole size | 4 mm | 4 mm | 4 mm | 4 mm | 4 mm |
| Die holes/how many | 3 | 3 | 3 | 3 | 3 |
| Die pressure psig | Record | 600 | 500 | 480-500 | 500 |
| P & S Drier | | | | | |
| East Temperature | Record | 200 | 200 | 200 | 200 |
| West Temperature | Record | 240 | 240 | 240 | 240 |

The products were analyzed to determine nutritive content, based on the following theoretical nutritive content of the feed ingredients.

Ingredients Nutritional Analysis Extruded Snack Product—100 g

Theoretical

| | Carbohydrate | Protein | Fat | Fiber | Energy |
|---|---|---|---|---|---|
| Ingredient | (g) | (g) | (g) | (g) | (Cal) |
| Cranberry Seed | 57.2 | 23.9 | 7.44 | 57.3 | 391 |
| Meal | | | | | |
| Proso Millet | 73.1 | 10.6 | 1.7 | 1.7 | 356 |
| Tapioca | 82 | 2.8 | 0.3 | 2 | 350 |
| Corn Meal | 77 | 6.9 | 3.9 | 7.3 | 361 |
| Salt | — | — | — | — | — |

The following results were obtained.

Trial 1

| | Carbohydrate | Protein | Fat | Fiber | Energy |
|---|---|---|---|---|---|
| Ingredient | (g) | (g) | (g) | (g) | (Cal) |
| Cranberry Seed | 6.864 | 2.868 | 0.8928 | 6.876 | 46.92 |
| Meal | | | | | |
| Proso Millet | 21.93 | 3.18 | 0.51 | 0.51 | 106.8 |
| Tapioca | 24.6 | 0.84 | 0.09 | 0.6 | 105 |
| Corn Meal | 21.56 | 1.932 | 1.092 | 2.044 | 101.08 |
| Total | 74.954 | 8.82 | 2.5848 | 10.03 | 359.8 |

Trial 2

| | Carbohydrate | Protein | Fat | Fiber | Energy |
|---|---|---|---|---|---|
| Ingredient | (g) | (g) | (g) | (g) | (Cal) |
| Cranberry Seed | 13.728 | 5.736 | 1.7856 | 13.752 | 93.84 |
| Meal | | | | | |
| Proso Millet | 21.93 | 3.18 | 0.51 | 0.51 | 106.8 |
| Tapioca | 24.6 | 0.84 | 0.09 | 0.6 | 105 |
| Corn Meal | 12.32 | 1.104 | 0.624 | 1.168 | 57.76 |
| Total | 72.578 | 10.86 | 3.0096 | 16.03 | 363.4 |

Trial 3

| | Carbohydrate | Protein | Fat | Fiber | Energy |
|---|---|---|---|---|---|
| Ingredient | (g) | (g) | (g) | (g) | (Cal) |
| Cranberry Seed | 20.592 | 8.604 | 2.6784 | 20.628 | 140.76 |
| Meal | | | | | |
| Proso Millet | 21.93 | 3.18 | 0.51 | 0.51 | 106.8 |
| Tapioca | 24.6 | 0.84 | 0.09 | 0.6 | 105 |
| Corn Meal | 3.08 | 0.276 | 0.156 | 0.292 | 14.44 |
| Total | 70.202 | 12.9 | 3.4344 | 22.03 | 367 |

Control

| | Carbohydrate | Protein | | Fiber | Energy |
|---|---|---|---|---|---|
| Ingredient | (g) | (g) | Fat (g) | (g) | (Cal) |
| Cranberry Seed | 0 | 0 | 0 | 0 | 0 |
| Meal | | | | | |
| Proso Millet | 21.93 | 3.18 | 0.51 | 0.51 | 106.8 |
| Tapioca | 24.6 | 0.84 | 0.09 | 0.6 | 105 |
| Corn Meal | 30.8 | 2.76 | 1.56 | 2.92 | 144.4 |
| Total | 77.33 | 6.78 | 2.16 | 4.03 | 356.2 |

The blends and extruded products were analyzed via a commercial testing facility and found to have the following nutritive makeup.

| | Carbo- | | | | Insol- | | Vitamin C |
|---|---|---|---|---|---|---|---|
| Trial | hydrates | Protein | Fat | Fiber | uble | Soluble | (mg/100 g) |
| Control- | 81.8 | 6.17 | 1.83 | 3.4 | 2.4 | 1 | <0.5 |
| Blend | | | | | | | |
| Control- | 81.9 | 9.55 | 1.93 | 3.7 | 3.5 | 0.2 | <0.5 |
| Product | | | | | | | |
| Trial 1- | 78.9 | 8.15 | 3.01 | 9.2 | 7.8 | 1.4 | <0.5 |
| Blend | | | | | | | |
| Trial 1- | 79.9 | 7.98 | 2.85 | 6.9 | 6.9 | 0 | <0.5 |
| Product | | | | | | | |
| Trial 2- | 78.5 | 9.94 | 3.5 | 16.2 | 13 | 3.2 | 1.3 |
| Blend | | | | | | | |
| Trial 2- | 78.1 | 9.58 | 3.43 | 12.2 | 10.4 | 1.8 | <0.5 |
| Product | | | | | | | |
| Trial 3- | 75.2 | 12.2 | 3.75 | 22.4 | 17.6 | 4.8 | 1.2 |
| Blend | | | | | | | |
| Trial 3- | 75.9 | 12.1 | 4.01 | 21.8 | 15.8 | 6 | <0.5 |
| Product | | | | | | | |

| | | | | Sodium |
|---|---|---|---|---|
| Trial | Sugar | Moisture | Calories | (mg/100 g) |
| Control-Blend | <1 | 9.61 | 368 | 29.3 |
| Control- Product | <1 | 9.55 | 369 | 22 |
| Trial 1- Blend | <1 | 8.98 | 375 | 14.3 |
| Trial 1- Product | <1 | 8.36 | 377 | 24.8 |
| Trial 2-Blend | 2 | 8.26 | 380 | 24.6 |
| Trial 2- Product | 1 | 7.66 | 382 | 25.5 |
| Trial 3- Blend | 2 | 7.29 | 383 | 24.9 |
| | 1 | 6.49 | 388 | 22.9 |

| | Calcium | Vitamin A | Iron |
|---|---|---|---|
| Trial | (mg/100 g) | (IU/100 g) | (mg/100 g) |
| Control-Blend | 15.9 | 104 | 2.49 |
| Control- Product | 17.6 | 100 | 7.74 |
| Trial 1- Blend | 47.5 | 244 | 2.85 |
| Trial 1- Product | 45.4 | 90 | 7.46 |
| Trial 2-Blend | 78.5 | 126 | 2.85 |
| Trial 2- Product | 70.4 | 92 | 5.12 |
| Trial 3- Blend | 107 | 103 | 3.73 |
| | 104 | 93 | 6.42 |

Dietary Fiber of Blends and Extrudates
Blends

| | Total Dietary Fiber | Soluble fiber | Insoluble fiber |
|---|---|---|---|
| Sample | (%) | (%) | (%) |
| Control | 3.4 | 1 | 2.4 |
| Trial 1 | 9.2 | 1.4 | 7.8 |
| Trial 2 | 16.2 | 3.2 | 13 |
| Trial 3 | 22.4 | 4.8 | 17.6 |

Extrudates

| | Total Dietary Fiber | Soluble fiber | Insoluble fiber |
|---|---|---|---|
| Sample | (%) | (%) | (%) |
| Control | 3.7 | 0.2 | 3.5 |
| Trial 1 | 6.9 | 0 | 6.9 |
| Trial 2 | 12.2 | 1.8 | 10.4 |
| Trial 3 | 21.8 | 6 | 15.8 |

### Example 6

The following blends were prepared and extruded in accordance with the procedure set forth above in Example 5.

| | | | | |
|---|---|---|---|---|
| Ingredients | Control | Trial 4 | Trial 5 | Trial 6 |

Percentage

| | | | | |
|---|---|---|---|---|
| Cranberry Seed | 0 | 24 | 30 | 36 |
| Meal | | | | |
| Proso Millet | 25 | 25 | 25 | 25 |
| Tapioca Starch | 25 | 25 | 25 | 25 |
| Corn Meal | 44.5 | 20.5 | 14.5 | 8.5 |
| Pure-set B965 | 5 | 5 | 5 | 5 |
| Salt | 0.5 | 0.5 | 0.5 | 0.5 |

Weight (lbs.)

| | | | | |
|---|---|---|---|---|
| Cranberry Seed | 0 | 42 | 52.5 | 63 |
| Meal | | | | |
| Proso Millet | 43.75 | 43.75 | 43.75 | 43.75 |
| Tapioca Starch | 43.75 | 43.75 | 43.75 | 43.75 |
| Corn Meal | 77.875 | 35.875 | 25.372 | 14.875 |
| Pure-set B965 | 8.75 | 8.75 | 8.75 | 8.75 |
| Salt | 0.875 | 0.875 | 0.875 | 0.875 |
| Total Blend Weight | 175 | 175 | 175 | 175 |

Extrusion conditions were as follows.

Extruder Data
Blends(% Cranberry seed Meal)

| | | | 24% | 30% | 36% |
|---|---|---|---|---|---|
| | Target | Control | Trial 4 | Trial 5 | Trial 6 |
| Raw Material | | | | | |
| Information | | | | | |
| Dry Recipe Rate lb./hr | 150 | 150 | 150 | 150 | 150 |
| Feed Screw Speed rpm | Record | 12 | 12 | 12 | 12 |
| Cylinder Information | | | | | |
| Cylinder Speed rpm | 300 | 300 | 300 | 300 | 300 |
| Extrusion Information | | | | | |
| Extruder barrel set up # | 7 | 7 | 7 | 7 | 7 |
| Extruder Shaft Speed | 300 | 300 | 300 | 300 | 300 |
| rpm | | | | | |
| Extruder Motor Load % | Record | 35 | 35 | 31 | 31 |
| Water Flow to Extruder | | 10 | 10 | 10 | 10 |
| lb./hr | | | | | |
| Knife Speed rpm | Record | 431 | 433 | 432 | 431 |
| No of Knives | 2 | 2 | 2 | 2 | 2 |
| Control Temp- 1st Head | 80-100 | 85 | 87 | 87 | 90 |
| Deg. F. | | | | | |
| Control Temp- 2nd Head | 150-170 | 123 | 159 | 125 | 140 |
| Deg. F. | | | | | |
| Control Temp- 3rd Head | 200-230 | 218 | 233 | 221 | 207 |
| Deg. F. | | | | | |
| Control Temp- 4th Head | 240-260 | 260 | 249 | 255 | 260 |
| Deg. F. | | | | | |
| Control Temp- 5th Head | 240-260 | 254 | 252 | 249 | 249 |
| Deg. F. | | | | | |
| Die hole size | 4 mm | 4 mm | 4 mm | 4 mm | 4 mm |
| Die holes/how many | 3 | 3 | 3 | 3 | 3 |
| Die pressure psig | Record | | 490 | 490 | 490 |
| P & S Drier | | | | | |
| East Temperature | Record | 185 | 192 | 190 | 190 |
| West Temperature | Record | 240 | 240 | 240 | 240 |

These products were analyzed for nutritional content, again calculated based on theoretical nutritive content of the feed ingredients. The following results were obtained.

Trial 4

| | Carbohydrates | Protein | Fat | Fiber | Energy |
|---|---|---|---|---|---|
| Ingredient | (g) | (g) | (g) | (g) | (Cal) |
| Cranberry Seed | 13.728 | 5.736 | 1.7856 | 13.752 | 93.84 |
| Meal | | | | | |
| Proso Millet | 18.275 | 2.65 | 0.425 | 0.425 | 89 |
| Tapioca | 20.5 | 0.7 | 0.075 | 0.5 | 87.5 |
| GPC Pure-Set | 4.475 | 0.015 | 0 | 0 | 18 |
| B965 | | | | | |
| Corn Meal | 15.785 | 1.4145 | 0.7995 | 1.4965 | 74.005 |
| Salt | 0 | 0 | 0 | 0 | 0 |
| Total | 72.763 | 10.5155 | 3.0851 | 16.1735 | 362.345 |

Trial 5

| | Carbohydrates | Protein | Fat | Fiber | Energy |
|---|---|---|---|---|---|
| Ingredient | (g) | (g) | (g) | (g) | (Cal) |
| Cranberry Seed | 17.16 | 7.17 | 2.232 | 17.19 | 117.3 |
| Meal | | | | | |
| Proso Millet | 18.275 | 2.65 | 0.425 | 0.425 | 89 |
| Tapioca | 20.5 | 0.7 | 0.075 | 0.5 | 87.5 |
| GPC Pure-Set | 4.475 | 0.015 | 0 | 0 | 18 |
| B965 | | | | | |
| Corn Meal | 11.165 | 1.0005 | 0.5655 | 1.0585 | 52.345 |
| Salt | 0 | 0 | 0 | 0 | 0 |
| Total | 71.575 | 11.5355 | 3.2975 | 19.1735 | 364.145 |

Trial 6

| Ingredient | Carbohydrates | Protein | Fat | Fiber | Energy |
|---|---|---|---|---|---|
| Cranberry Seed | 20.592 | 8.604 | 2.6784 | 20.628 | 140.76 |
| Meal | | | | | |
| Proso Millet | 18.275 | 2.65 | 0.425 | 0.425 | 89 |
| Tapioca | 20.5 | 0.7 | 0.075 | 0.5 | 87.5 |
| GPC Pure-Set | 4.475 | 0.015 | 0 | 0 | 18 |
| B965 | | | | | |
| Corn Meal | 6.545 | 0.5865 | 0.3315 | 0.6205 | 30.685 |
| Salt | 0 | 0 | 0 | 0 | 0 |
| Total | 70.387 | 12.5555 | 3.5099 | 22.1735 | 365.945 |

Control

| | Carbohydrates | Protein | Fat | Fiber | Energy |
|---|---|---|---|---|---|
| Ingredient | (g) | (g) | (g) | (g) | (Cal) |
| Cranberry Seed | 0 | 0 | 0 | 0 | 0 |
| Meal | | | | | |
| Proso Millet | 18.275 | 2.65 | 0.425 | 0.425 | 89 |
| Tapioca | 20.5 | 0.7 | 0.075 | 0.5 | 87.5 |
| GPC Pure-Set | 4.475 | 0.015 | 0 | 0 | 18 |
| B965 | | | | | |
| Corn Meal | 34.265 | 3.0705 | 1.7355 | 3.2485 | 160.645 |
| Salt | 0 | 0 | 0 | 0 | 0 |
| Total | 77.515 | 6.4355 | 2.2355 | 4.1735 | 355.145 |

The product of Trial 4 had a protein content of about 10.5% and a fiber content of about 16.2%. The product of Trial 5 had a protein content of about 11.6% and a fiber content of about 19.2%. The product of Trial 6 had a protein content of about 12.6% and a fiber content of about 22.2%. The control had a protein content of about 6.4% and a fiber content of about 4.2%.

Color was measured using HunterLab ColorFlex EZ color meter by filling the sample cup with sample to 45 mm mark and obtaining L*, a*, b* values in triplicates. The following results were obtained

Control

| Replicate | L* | a* | b* | Y* |
|---|---|---|---|---|
| | 56.38 | 2.95 | 25.88 | 24.3 |
| | 55.81 | 3 | 25.89 | 23.72 |
| | 56.53 | 2.9 | 25.91 | 24.44 |
| Average | 56.24 | 2.95 | 25.89 | 24.15 |

Trial 4

| Replicate | L* | a* | b* | Y* |
|---|---|---|---|---|
| | 44.61 | 8.62 | 16.97 | 14.27 |
| | 44.6 | 8.69 | 16.9 | 14.26 |
| | 44.6 | 8.68 | 16.88 | 14.26 |
| Average | 44.60 | 8.66 | 16.92 | 14.26 |

Trial 5

| Replicate | L* | a* | b* | Y* |
|---|---|---|---|---|
| | 38.36 | 8.66 | 14.83 | 10.29 |
| | 38.36 | 8.66 | 14.83 | 10.29 |
| | 38.32 | 8.63 | 14.8 | 10.27 |
| Average | 38.35 | 8.65 | 14.82 | 10.28 |

Trial 6

| Replicate | L* | a* | b* | Y* |
|---|---|---|---|---|
| | 40.38 | 9.41 | 16.12 | 11.48 |
| | 39.85 | 9.33 | 15.93 | 11.16 |
| | 40.58 | 9.47 | 16.2 | 11.6 |
| Average | 40.27 | 9.40 | 16.08 | 11.41 |

The FIGURE represents a plot of this color space data, which demonstrates that the greater the percentage of cranberry seed meal in the formulation, the more brown the product becomes. This was generally confirmed via visual observation.

A pH reading was obtained for the samples using Fisher Scientific ABIS plus pH meter upon performing a 2-point calibration of pH buffers 4 and 7. Two grams of each sample in a five ounce plastic cup was dissolved in 20 ml distilled water and a pH reading obtained in duplicate. The following results were obtained:

pH

| Sample | Replicate I | Replicate II | Average |
|---|---|---|---|
| Control | 4.81 | 4.84 | 4.83 |
| Trial 4 | 2.71 | 2.7 | 2.71 |
| Trial 5 | 2.37 | 2.37 | 2.37 |
| Trial 6 | 2.21 | 2.2 | 2.21 |

Moisture contents of the extrudates were determined by drying the samples in an oven set at 105° C. overnight for 16 hrs. and calculating the moisture content through weight reduction. The following results were obtained.

| | | | Weight | | |
|---|---|---|---|---|---|
| | | Weight | Pan + | Weight | |
| | | of product | Product | product | |
| | Weight | before | after | after | % |
| Sample | of Cup | Drying | Drying | drying | Moisture |
| ID | (g) | (g) | (g) | (g) | Content |
| C-1 | 1.32 | 15.139 | 14.734 | 13.414 | 11.39% |
| C-2 | 1.31 | 15.358 | 14.934 | 13.624 | 11.29% |
| C-3 | 1.315 | 15.46 | 14.992 | 13.677 | 11.53% |
| | | | | | 11.41% |
| T4-1 | 1.32 | 15.895 | 15.693 | 14.373 | 9.58% |
| T4-2 | 1.312 | 15.188 | 15.055 | 13.743 | 9.51% |
| T4-3 | 1.302 | 15.482 | 15.318 | 14.016 | 9.47% |
| | | | | | 9.52% |
| T5-1 | 1.311 | 15.744 | 15.644 | 14.333 | 8.96% |
| T5-2 | 1.321 | 15.51 | 15.402 | 14.081 | 9.21% |
| T5-3 | 1.324 | 15.906 | 15.804 | 14.48 | 8.97% |
| | | | | | 9.05% |
| T6-1 | 1.307 | 15.191 | 15.199 | 13.892 | 8.55% |
| T6-2 | 1.314 | 15.808 | 15.746 | 14.432 | 8.70% |
| T6-3 | 1.331 | 15.424 | 15.449 | 14.118 | 8.47% |
| | | | | | 8.57% |

An Aqua Lab water activity meter 4TE DUO was used to obtained the water activity of the ground extrudate samples. An 0.500 a_{W} standard for powders was utilized to standardize the meter with a reading of 0.499 within ±0.003 water activity. The water activity readings were measured in duplicates. The following results were obtained:

Control

| | | Temp |
|---|---|---|
| Replicate | a_{W} | (° C.) |
| I | 0.2039 | 25.03 |
| II | 0.203 | 25.02 |
| Average | 0.2035 | 25.03 |

Trial 4

| | | Temp |
|---|---|---|
| Replicate | a_{W} | (° C.) |
| I | 0.2261 | 25.01 |
| II | 0.2254 | 25.01 |
| Average | 0.2258 | 25.01 |

Trial 5

| | | Temp |
|---|---|---|
| Replicate | a_{W} | (° C.) |
| I | 0.2219 | 25.02 |
| II | 0.2212 | 25.02 |
| Average | 0.2216 | 25.02 |

Trial 6

| | | Temp |
|---|---|---|
| Replicate | a_{W} | (° C.) |
| I | 0.2188 | 25.04 |
| II | 0.2177 | 25.04 |
| Average | 0.2183 | 25.04 |

Expansion ratios (ER) of the cylindrical extrudate samples were obtained using a vernier caliper in micrometer to measure the diameter. Ten pieces of the extrudates were measured and averaged following the formula below:

$$ER = \frac{Diameter of the extrudate ( mm )}{Diameter of the idle ( mm )}$$

The following results were obtained:

| | | Diameter | Expansion |
|---|---|---|---|
| Sample | Replicate | (mm) | Ratio |
| Control | I | 14.07 | 3.518 |
| | II | 14.53 | 3.633 |
| | III | 15.33 | 3.833 |
| | IV | 14.51 | 3.628 |
| | V | 14.3 | 3.575 |
| | VI | 14.53 | 3.633 |
| | VII | 14.59 | 3.648 |
| | VIII | 14.77 | 3.693 |
| | IX | 13.61 | 3.403 |
| | X | 14.89 | 3.723 |
| Average | | 14.51 | 3.628 |
| Trial 4 | I | 11.18 | 2.795 |
| | II | 11.17 | 2.793 |
| | III | 9.78 | 2.445 |
| | IV | 10.06 | 2.515 |
| | V | 11.46 | 2.865 |
| | VI | 10.39 | 2.598 |
| | VII | 12.17 | 3.043 |
| | VIII | 10.13 | 2.533 |
| | IX | 11.79 | 2.948 |
| | X | 11.67 | 2.918 |
| Average | | 10.98 | 2.745 |
| Trial 5 | I | 10.14 | 2.535 |
| | II | 9.83 | 2.458 |
| | III | 10.22 | 2.555 |
| | IV | 9.64 | 2.410 |
| | V | 10.71 | 2.678 |
| | VI | 9.84 | 2.460 |
| | VII | 9.49 | 2.373 |
| | VIII | 8.91 | 2.228 |
| | IX | 8.74 | 2.185 |
| | X | 10.27 | 2.568 |
| Average | | 9.78 | 2.445 |
| Trial 6 | I | 9.45 | 2.363 |
| | II | 9.64 | 2.410 |
| | III | 9.39 | 2.348 |
| | IV | 8.98 | 2.245 |
| | V | 9.32 | 2.330 |
| | VI | 8.97 | 2.243 |
| | VII | 9.45 | 2.363 |
| | VIII | 9.1 | 2.275 |
| | IX | 9.37 | 2.343 |
| | X | 9.66 | 2.415 |
| Average | | 9.33 | 2.333 |

The actual dimensions of the extrudates were measured to calculate the bulk density. Vernier caliper was used to measure the diameter and the length of the extrudates. Assuming a cylindrical shape of the extrudates, the bulk density was calculated using the formula below:

ρ_{b}=4/πd²l

where ρ_{b}=bulk density (g/cm3); d=diameter of the extrudate (cm); l=length per gram of the extrudate (cm/g). Five pieces of extrudates were randomly selected and an average obtained on diameter and length per gram. The following results were obtained.

| | | | | | | | | Bulk |
|---|---|---|---|---|---|---|---|---|
| | | Diameter | Diameter | d² | Length | Weight | Length/ | Density |
| Sample | Replicate | (mm) | (cm) | (cm2) | (cm) | (g) | gram | (g/cm3) |
| Control | I | 13.47 | 1.35 | 1.81 | 27.72 | 0.407 | 68.11 | 0.010 |
| | II | 14.32 | 1.43 | 2.05 | 27.29 | 0.391 | 69.80 | 0.009 |
| | III | 13.77 | 1.38 | 1.90 | 27.79 | 0.377 | 73.71 | 0.009 |
| | IV | 13.53 | 1.35 | 1.83 | 25.76 | 0.375 | 68.69 | 0.010 |
| | V | 13.33 | 1.33 | 1.78 | 25.7 | 0.389 | 66.07 | 0.011 |
| Average | | 13.68 | 1.37 | 1.87 | 26.85 | 0.388 | 69.24 | 0.010 |
| Trial 4 | I | 11.9 | 1.19 | 1.42 | 33.14 | 0.477 | 69.48 | 0.013 |
| | II | 10.49 | 1.05 | 1.10 | 26.74 | 0.386 | 69.27 | 0.017 |
| | III | 12.62 | 1.26 | 1.59 | 38.43 | 0.597 | 64.37 | 0.012 |
| | IV | 11.63 | 1.16 | 1.35 | 33.18 | 0.507 | 65.44 | 0.014 |
| | V | 12.11 | 1.21 | 1.47 | 33.91 | 0.478 | 70.94 | 0.012 |
| Average | | 11.75 | 1.18 | 1.38 | 33.08 | 0.489 | 67.65 | 0.014 |
| Trial 5 | I | 10.70 | 1.07 | 1.14 | 41.7 | 0.617 | 67.59 | 0.016 |
| | II | 10.49 | 1.05 | 1.10 | 43.02 | 0.637 | 67.54 | 0.017 |
| | III | 10.00 | 1.00 | 1.00 | 41.64 | 0.604 | 68.94 | 0.018 |
| | IV | 8.66 | 0.87 | 0.75 | 26.09 | 0.389 | 67.07 | 0.025 |
| | V | 9.31 | 0.93 | 0.87 | 25.05 | 0.372 | 67.34 | 0.022 |
| Average | | 9.83 | 0.98 | 0.97 | 35.50 | 0.524 | 67.77 | 0.019 |
| Trial 6 | I | 10.03 | 1.00 | 1.01 | 32.84 | 0.543 | 60.48 | 0.021 |
| | II | 8.54 | 0.85 | 0.73 | 23.74 | 0.258 | 92.02 | 0.019 |
| | III | 9.41 | 0.94 | 0.89 | 37.87 | 0.63 | 60.11 | 0.024 |
| | IV | 8.18 | 0.82 | 0.67 | 26.32 | 0.435 | 60.51 | 0.031 |
| | V | 10.3 | 1.03 | 1.06 | 37.64 | 0.618 | 60.91 | 0.020 |
| Average | | 9.29 | 0.93 | 0.86 | 31.68 | 0.497 | 63.77 | 0.023 |

Water absorption index of the extrudates was determined by utilizing a method outlined by Anderson, Conway, Pfeifer, and Griffin (1969). 2.5 grams of the ground sample was suspended into 30 ml distilled water at room temperature (21-23° C.) in a 50 ml tarred centrifuge tube in duplicate. The contents were stirred every 5 minutes over 30 minutes period and centrifuged at 3000×g for 10 minutes using Thermo IEC CENTRA CL2 centrifuge. Into a tarred evaporating dish, the supernatant liquid was poured off and the remaining sediment weighed and WAI obtained using the formula below:

$$WAI ( g \text{/} g ) = \frac{Weight of sediment}{Weight of dry solids}$$

The following results were obtained.

| | Weight of | Weight of | Weight of | Weight of | |
|---|---|---|---|---|---|
| | tube | sample | sediment + tube | Sediment | WAI |
| Sample | (g) | (g) | (g) | (g) | (g/g) |
| Control-I | 96.652 | 2.509 | 112.393 | 15.741 | 6.274 |
| Control-II | 96.652 | 2.53 | 112.396 | 15.744 | 6.223 |
| Average | | 2.520 | | 15.743 | 6.248 |
| Trial 4 | | | | | |
| I | 96.777 | 2.511 | 108.651 | 11.874 | 4.729 |
| II | 96.777 | 2.505 | 108.813 | 12.036 | 4.805 |
| Average | | 2.508 | | 11.955 | 4.767 |
| Trial 5 | | | | | |
| I | 96.521 | 2.506 | 106.829 | 10.308 | 4.113 |
| II | 96.521 | 2.503 | 107.053 | 10.532 | 4.208 |
| Average | | 2.505 | | 10.420 | 4.161 |
| Trial 6 | | | | | |
| I | 96.396 | 2.514 | 105.71 | 9.314 | 3.705 |
| II | 96.396 | 2.518 | 105.805 | 9.409 | 3.737 |
| Average | | 2.516 | | 9.362 | 3.721 |

Water solubility index of the extrudates was determined from the water absorption index test described above from the amount of the dried solids recovered by evaporating the supernatant. WSI was obtained using the formula below:

$$WSI ( \% ) = \frac{Weight of dissolved solid in supernatant}{Weight of dry solids} \times 100$$

The following results were obtained.

| Weight of | Weight of pan + | Weight of dissolved | |
|---|---|---|---|
| supernate | dry product | solid in supernate | WSI |
| (g) | (g) | (g) | (%) |
| 14.085 | 1.616 | 0.302 | 12.04 |
| 14.295 | 1.625 | 0.314 | 12.41 |
| | | 0.308 | 12.22 |
| 18.055 | 1.836 | 0.509 | 20.27 |
| 17.794 | 1.831 | 0.515 | 20.56 |
| | | 0.512 | 20.41 |
| 20.406 | 1.871 | 0.551 | 21.99 |
| 20.592 | 1.856 | 0.554 | 22.13 |
| | | 0.553 | 22.06 |
| 21.247 | 1.919 | 0.592 | 23.55 |
| 19.853 | 1.941 | 0.621 | 24.66 |
| | | 0.607 | 24.11 |

A pellet durability tester was utilized to predict the amount of fines that would exist in the extrudates upon reaching the consumer after transportation. To prepare the sample hand sieve was used to separate broken extrudates. 500 grams of the screened extrudates were weighed, placed in the three compartments of the tester and tumbled for 10 minutes. Extrudates were retrieved from the tester compartment rescreened and weighed. PDI was computed using the formula below:

$$PDI = \frac{Weight of rescreened sample ( g )}{Weight of sample ( 500 g )} \times 100$$

The following results were obtained:

| | | | Empty | Weight of | Weight | |
|---|---|---|---|---|---|---|
| | | | weight | whole pel- | of | Pellet |
| | | Weight | of | lets after + | whole | Dura- |
| | Repli- | before | container | container | pellet | bility |
| Sample | cate | (g) | (g) | (g) | (g) | Index |
| Control | I | 500.58 | 768.61 | 1070.18 | 301.57 | 60.24 |
| | II | 500.36 | 768.61 | 1068.93 | 300.32 | 60.02 |
| Average | | | | | | 60.13 |
| Trial 4 | I | 500.17 | 823.92 | 1142.04 | 318.12 | 63.60 |
| | II | 500.76 | 823.92 | 1142.58 | 318.66 | 63.64 |
| Average | | | | | | 63.62 |
| Trial 5 | I | 500.09 | 768.61 | 1115.55 | 346.94 | 69.38 |
| | II | 500.69 | 768.61 | 1118.37 | 349.76 | 69.86 |
| Average | | | | | | 69.62 |
| Trial 6 | I | 500.5 | 823.92 | 1181.94 | 358.02 | 71.53 |
| | II | 500.61 | 823.91 | 1182.27 | 358.36 | 71.58 |
| Average | | | | | | 71.56 |

### Example 7

### Anthocyanin Survival

Using the methodology described above, samples of the blend to be extruded were eluted and compared to the reference anthocyanin standards. This was repeated for the extruded, expanded product, and the results compared to determine the anthocyanin survival rate. The following results were obtained.

| Cranberry Seed | | | | | |
|---|---|---|---|---|---|
| Meal % | C-3-GA | C-3-GI | C-3-Ar | P-3-Ga | P-3-GI |
| | Percent Survival | | | | |
| Trial 1 | 19.40% | ND | 0.00% | 18.18% | ND |
| Trial 2 | 18.31% | ND | 16.43% | 17.38% | ND |
| Trial 3 | 13.61% | ND | 13.51% | 13.99% | 0.00% |
| Trial 5 | 12.69% | ND | 0.00% | 12.03% | 0.00% |
| | Percent Loss | | | | |
| Trial 1 | 80.60% | ND | 100.00% | 81.82% | ND |
| Trial 2 | 81.69% | ND | 83.57% | 82.62% | ND |
| Trial 3 | 86.39% | ND | 86.49% | 86.01% | 100.00% |
| Trial 5 | 87.31% | ND | 100.00% | 87.97% | 100.00% |

ND—None detected

Surprisingly, a substantial percentage of C-3-Ga and P-3-Ga survived the extrusion process for each of the above runs.

It is thus seen that an extruded, expanded product may be prepared in accordance with the above teachings. In many embodiments the product is suitable for use as a snack product for consumption by the general population, but in particular for diabetics. The product has high percentages of protein and fiber and can be made to have surviving anthocyanins.

All weight percentages stated herein are on a dry solids basis unless clearly indicated otherwise.

All references cited herein are hereby incorporated by references in their entireties. Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A method comprising:
providing a cranberry seed meal, said cranberry seed meal containing at least one anthocyanin;
blending said cranberry seed meal with a starch to form a blend; and
extruding said blend through a die under selected conditions effective to create an expanded extrudate; said extrudate exhibiting a survival rate of at least 10% of at least one anthocyanin selected from among cyanidin-3-galactoside, cyanidin-3-arabinoside, cyanidin-3-glucoside, peonidin-3-galactoside, peonidin-3-arabinoside, and peonidin-3-glucoside.

2. A method according to claim 1, said cranberry seed meal being present in said blend in an amount of about 5-40%.

3. A method according to claim 2, said cranberry seed meal being present in said blend in an amount of about 10-35%.

4. A method according to claim 2, said cranberry seed meal being present in said blend in an amount of about 20-30%.

5. A method according to claim 1, said surviving anthocyanin comprising cyanidin-3-arabinoside.

6. A method according to claim 1, said surviving anthocyanin comprising peonidin-3-galactoside.

7. A method according to claim 1, said extrudate exhibiting a 10% survival rate of at least two anthocyanins.

8. A method according to claim 7, said anthocyanins being cyanidin-3-arabinoside and peonidin-3-galactoside.

9. A method according to claim 1, said starch being present in said blend in an amount of from 30-60%, exclusive of starch derived from whole grain components of said blend.

10. A method according to claim 9, said starch comprising a modified dent corn starch.

11. The product prepared in accordance with the method of claim 1.

12. The product of claim 11, containing cranberry seed in an amount of about 5-40%.

13. The product of claim 12, containing cranberry seed in an amount of about 10-35%.

14. The product of claim 13, containing cranberry seed in an amount of about 20-30%.

15. The product of claim 14, further containing extruded proso millet, dent corn starch, and tapioca starch.

16. The product of claim 11, including a protein content of at least about 7.5% and a fiber content of at least about 6.0%
